(19) United States
(12) Patent Application Publication
(10) Pub. No.: US 2025/0053704 A1
(43) Pub. Date: Feb. 13, 2025

(54) METHOD AND SYSTEM FOR OPTIMIZING DESIGN OF HIGH-PRESSURE HYDROGEN STORAGE COMPOSITE WOUND GAS CYLINDER

(71) Applicants: NANJING TECH UNIVERSITY, Nanjing (CN); JILIN INSTITUTE OF CHEMICAL TECHNOLOGY, Jilin City (CN)

(72) Inventors: Shiming DUAN, Nanjing (CN); Xiaofeng LU, Nanjing (CN); Qing CHEN, Jilin City (CN); Xiaolei ZHU, Nanjing (CN); Xinfang ZENG, Jilin City (CN); Lei SHANG, Jilin City (CN)

(21) Appl. No.: 18/502,655

(22) Filed: Nov. 6, 2023

(30) Foreign Application Priority Data
Aug. 9, 2023 (CN) 2023110043356

(51) Int. Cl. G06F 30/23; F17C 1/06

(52) U.S. Cl. CPC G06F 30/23; F17C 1/06; F17C 2201/0104; F17C 2203/0673; F17C 2209/00; F17C 2221/012; F17C 2260/017; G06F 2111/10

(57) ABSTRACT

Provided are a method and a system for optimizing a design of a high-pressure hydrogen storage composite wound gas cylinder. The method includes: S1, determining a preliminary design result according to a film theory and a grid theory; S2, establishing a three-dimensional solid refined model of the preliminary design result based on a finite element analysis software; and S3, applying the three-dimensional solid refined model for a simulation analysis, and applying a response surface or a genetic algorithm for an optimization design.

### CROSS-REFERENCE TO RELATED APPLICATIONS

This disclosure claims priority to Chinese Patent Application No. 202311004335.6, filed on Aug. 9, 2023, the contents of which are hereby incorporated by reference.

### TECHNICAL FIELD

The disclosure belongs to a technical field of high-pressure vessels, and in particular to a method and a system for optimizing a design of a high-pressure hydrogen storage composite wound gas cylinder.

### BACKGROUND

Compressed gas hydrogen storage is the simplest and most mature hydrogen storage technology, and is also the first choice for hydrogen fuel cell vehicles. At present, the design of the high-pressure composite wound gas cylinder is consisted of a conventional design and an analytical design. The metal inner container of Type III cylinder adopts the conventional design based on a thin film theory and the analytical design based on an elastic-plastic theory, and a fiber winding layer adopts the conventional design based on a grid theory and the analytical design based on an elastic theory. The design method of Type IV cylinder is slightly different, and the polar hole structure of variable material should be designed. The conventional analysis design assumes a same thickness of the fiber winding layer at the head, ignoring an objective fact of the fiber winding layer at the head having changing angle and thickness, thus leading to a great deviation between the analysis results at the head and even the overall gas cylinder and the actual situation. In order to solve the problem, the disclosure provides a method for optimizing a design of a high-pressure hydrogen storage composite wound gas cylinder based on refined model, realizing the refined modeling of fiber winding layer with variable angle and thickness at the head, and realizing the multi-objective optimization design of ply stacking sequence, ply stacking thickness and ply stacking angle based on the response surface or the genetic algorithm as a whole, so as to achieve goals of reasonable stress distribution of winding layer and further weight reduction.

### SUMMARY

In view of the above problems, the disclosure aims to propose a method and a system for optimizing a design of a high-pressure hydrogen storage composite wound gas cylinder. The method includes following steps:
S1, determining a preliminary design result according to a film theory and a grid theory, where the preliminary design result includes a thickness of an inner container of a high-pressure composite wound gas cylinder and a thickness of a composite reinforced layer;
S2, establishing a three-dimensional solid refined model of the preliminary design result based on a finite element analysis method; and
S3, carrying out a multi-objective optimization design of the high-pressure composite wound gas cylinder by applying a response surface or a genetic algorithm based on the three-dimensional solid refined model.

Optionally, a method for calculating the thickness of the inner container of the high-pressure composite material wound gas cylinder includes following steps:

$${t}_{i} = \frac{{P}_{i} D}{2 {R}_{mi} + {P}_{i}}$$

where tᵢ represents the thickness of the inner container, Pᵢ represents a minimum design bursting pressure of the inner container, D represents an outer diameter of the inner container, and Rₘᵢ represents a minimum guaranteed value of a tensile strength of an inner container material after heat treatment;
a minimum thickness of a neck diameter of the inner container is calculated according to a following formula:

$${t}_{i 0 min} = \frac{{P}_{b} {d}_{i 0}}{2 {R}_{mi} + {P}_{b}}$$

where tᵢ₀ₘᵢₙ represents the minimum thickness of the neck diameter of the inner container, P_{b} represents an actual design bursting pressure of the gas cylinder, and dᵢ₀ represents an outer diameter of the inner container bottle mouth.

Optionally, a method for calculating the thickness of the composite reinforced layer includes:

$${t}_{os} = \frac{{P}_{b} D - 4 {R}_{mi} {t}_{i}}{4 k {cos}^{2} α {R}_{mo}}$$

where tₒₛ represents a layer thickness of a spiral layer of the composite reinforced layer, Rₘₒ represents a minimum guaranteed value of a tensile strength of the composite, α represents a winding angle and k represents a balance coefficient;

$${t}_{oh} = \frac{{P}_{b} D}{4 {R}_{mo}} ( 2 - \frac{1}{k} {tan}^{2} α ) - \frac{{R}_{mi} {t}_{i}}{{R}_{mo}}$$

where tₒₕ represents a thickness of a circumferential layer of the composite reinforced layer, and a circumferential reinforcement structure consists of two parts, one part is provided by the circumferential layer, and the other part is provided by the spiral layer;
a calculation formula of the thickness tₒ of the composite reinforced layer is as follows:

$${t}_{o} = {t}_{os} + {t}_{oh} .$$

Optionally, in the S2, a process of establishing the three-dimensional solid refined model includes an establishment of the inner container model and an establishment of the composite reinforced layer.

Optionally, a method for establishing the composite reinforced layer includes following steps:
the reinforced layer of composite material may be divided into a circumferential layer modeling and a spiral layer modeling. The circumferential layer is performed with a ply stacking modeling by using 90° fibers, the spiral layer is performed with a ply stacking modeling according to a preliminarily designed ply angle, and the ply stacking modeling method with variable angle and thickness is used at the head. The modified cubic spline thickness formula is used for a data calculation and then the ply stacking modeling is carried out.

Optionally, a method for carrying out a ply stacking modeling after the data calculation by using the modified cubic spline thickness formula includes:
a modified cubic spline function for calculating a thickness of the head is as follows:

$$t ( {r}_{i} ) = {m}_{1} \times {r}_{i}^{0} + {m}_{2} \times {r}_{i}^{1} + {m}_{3} \times {r}_{i}^{2} + {m}_{4} \times {r}_{i}^{3}$$

where m₁, m₂, m₃, m₄ represent undetermined coefficients and rᵢ represents a distance from a central axis;
a formula for determining m₁, m₂, m₃, m₄ is as follows:

$$[ \begin{matrix}{m}_{1} \\ {m}_{2} \\ {m}_{3} \\ {m}_{4}\end{matrix} ] = {[ \begin{matrix}1 & {r}_{0} & {r}_{0}^{2} & {r}_{0}^{3} \\ 1 & {r}_{2 b} & {r}_{2 b}^{2} & {r}_{2 b}^{3} \\ 0 & 1 & 2 {r}_{2 b} & 3 {r}_{2 b}^{2} \\ 1 & {r}_{2.2 b} & {r}_{2.2 b}^{2} & {r}_{2.2 b}^{3}\end{matrix} ]}^{- 1} \times [ \begin{matrix}{t}_{R} \cdot π R \cdot cos {α}_{0} / ( {m}_{0} \cdot b ) \\ \frac{{m}_{R} \cdot {n}_{R}}{π} \cdot [ arccos ( \frac{{r}_{0}}{{r}_{2 b}} ) - arccos ( \frac{{r}_{0} + b}{{r}_{2 b}} ) ] \cdot {t}_{p} \\ \frac{{m}_{R} \cdot {n}_{R}}{π} \cdot ( \frac{{r}_{0}}{{r}_{2 b} \times \sqrt{{r}_{2 b}^{2} - {r}_{0}^{2}}} - \frac{{r}_{0}}{{r}_{2 b} \times \sqrt{{r}_{2 b}^{2} - {r}_{b}^{2}}} ) \cdot {t}_{p} \\ \frac{{m}_{R} \cdot {n}_{R}}{π} \cdot [ arccos ( \frac{{r}_{0}}{{r}_{2.2 b}} ) - arccos ( \frac{{r}_{0} + b}{{r}_{2.2 b}} ) ] \cdot {t}_{p}\end{matrix} ]$$

where m_{R} represents a number of yarn bands in each single layer of a cylinder body, n_{R} represents a total number of single layers, tₚ represents a thickness of single layer yarn bands, m₀ represents a number of yarn pieces at a polar hole, m_{R}·n_{R} represents a total number of yarn bands, and m_{R}·n_{R}·tₚ represents a total thickness of yarn bands in the cylinder body;
formulas for calculating a winding angle at the polar hole of the head are as follows:
a spherical head formula:

$$α = arcsin ( \frac{{r}_{0}}{R} ) \times \frac{180}{π}$$

an elliptical head formula:

$$α = arc sin ( \frac{{r}_{0}^{2}}{{r}_{0}^{2} + ( {R}^{2} - {r}_{0}^{2} ) \frac{{h}^{2}}{{R}^{2}}} ) \times \frac{180}{π}$$

where r₀ represents the polar hole radius, and R represents an outside radius of the cylinder body;
formulas for calculating a winding angle of the head are as follows:
a spherical head formula:

$$α = arc sin ( \frac{{r}_{0}}{{r}_{i}} ) \times \frac{180}{π}$$

an elliptical head formula:

$$α = arc cos ( cos ψ \cdot cos φ \sqrt{\frac{{R}^{2} - ( {R}^{2} - {h}^{2} ) \cdot \frac{{sin}^{2} ψ}{{sin}^{2} ψ + {cos}^{2} ψ \cdot {sin}^{2} φ}}{{R}^{2} - ( {R}^{2} - {h}^{2} ) \cdot \frac{{cos}^{2} ψ \cdot {cos}^{2} φ \cdot {sin}^{2} ψ}{{sin}^{2} ψ + {cos}^{2} ψ \cdot {sin}^{2} φ}}} ) \times \frac{180}{π}$$

where rᵢ represents a radius from point i at the head to a rotating shaft, ψ represents an included angle between a plane where a geodesic line is located and an XZ plane, and φ represents an included angle between a plane of meridian and the XZ plane, and a method for calculating ψ and φ is as follows:

$${sin}^{2} ψ = \frac{{r}_{0}^{2}}{{R}^{2}}$$

$${sin}^{2} ψ = \frac{{R}^{2} - {r}^{2}}{{r}^{2}} \cdot \frac{{r}_{0}^{2}}{{R}^{2} - {r}_{0}^{2}} .$$

Optionally, an application and a solution of boundary conditions are further included in the S2:
one end of the gas cylinder is fixed or other fixed constraints are selected; the load is pressurized on an inner surface of the inner container, where a self-tightening pressure of a metal inner container needs to be calculated, and a CAE analysis and calculation are carried out after loading. The pressure loading process is as follows:
process 1: the internal pressure of the gas cylinder rises from a zero pressure to the self-tightening pressure;
process 2: the internal pressure of the gas cylinder declines from the self-tightening pressure to the zero pressure;
process 3: the internal pressure of the gas cylinder rises from the zero pressure to a nominal working pressure;
process 4: the internal pressure of the gas cylinder rises from the nominal working pressure to a hydraulic fatigue test pressure;
process 5: the internal pressure of the gas cylinder rises from the hydraulic fatigue test pressure to a hydraulic test pressure of the gas cylinder; and
process 6: the internal pressure of the gas cylinder rises from the hydraulic test pressure of the gas cylinder to a hydraulic bursting pressure of the gas cylinder;
where the self-tightening pressure is estimated by several groups of data for trial calculation, and then the self-tightening pressure is determined according to following restrictions:
a, under the working pressure, the fiber stress of the winding layer cannot exceed 30% of a strength limit;
b, under the working pressure, the stress of the metal inner container cannot exceed 60% of a yield limit;
c, under the zero pressure, a compressive stress of the metal inner container cannot exceed 95% of the yield limit, but is above 60% of the yield limit; and
d, the maximum stress at the head of the winding layer of the gas cylinder is always less than the maximum stress at the cylinder body.

The disclosure also discloses a system for optimizing a design of a high-pressure hydrogen storage composite wound gas cylinder, the system includes a preliminary design result acquisition module, a model establishment module and a multi-objective optimization design module;
the preliminary design result acquisition module is used for determining a preliminary design result according to a film theory and a grid theory, and the preliminary design result includes a thickness of an inner container of a high-pressure composite wound gas cylinder and a thickness of a composite reinforced layer;
the model establishment module is used for establishing a three-dimensional solid refined model of the preliminary design result based on a finite element analysis method; and
the multi-objective optimization design module is used for carrying out a multi-objective optimization design of the high-pressure composite wound gas cylinder by applying a response surface or a genetic algorithm based on the three-dimensional solid refined model.

Compared with the prior art, the disclosure has following beneficial effects:

The embodiment provides a method and a system for optimizing a design of a high-pressure hydrogen storage composite wound gas cylinder, realizing the refined modeling of fiber winding layer with variable angle and thickness at the head, and realizing the multi-objective optimization design of ply stacking sequence, ply stacking thickness and ply stacking angle based on the response surface or the genetic algorithm as a whole, so as to achieve goals of a reasonable stress distribution of the winding layer and a further weight reduction.

### BRIEF DESCRIPTION OF THE DRAWINGS

In order to explain the technical scheme of this disclosure more clearly, the drawings needed in the embodiments are briefly introduced below. Obviously, the drawings in the following description are only some embodiments of this disclosure. For ordinary technicians in this field, other drawings may be obtained according to these drawings without paying creative labor.

FIG. 1 is a method step diagram of a method and a system for optimizing a design of a high-pressure hydrogen storage composite wound gas cylinder according to an embodiment of the present disclosure.

FIG. 2 is a method step diagram of carrying out a multi-objective optimization design of the high-pressure composite wound gas cylinder based on a response surface or a genetic algorithm in the method and the system for optimizing the design of the high-pressure hydrogen storage composite wound gas cylinder according to an embodiment of the present disclosure.

FIG. 3 is a schematic diagram of a geodesic line and a meridian line according to an embodiment of the present disclosure.

### DETAILED DESCRIPTION OF THE EMBODIMENTS

In the following, technical schemes in the embodiments of the disclosure is clearly and completely described with reference to the attached drawings in the embodiments of the disclosure. Obviously, the described embodiments are only a part of embodiments of the disclosure, but not all embodiments. Based on the embodiments in this disclosure, all other embodiments obtained by ordinary technicians in this field without creative work belong to the protection scope of this disclosure.

In order to make the above objects, features and advantages of this disclosure more obvious and easier to understand, the disclosure is further described in detail with the attached drawings and specific embodiments.

### Embodiment 1

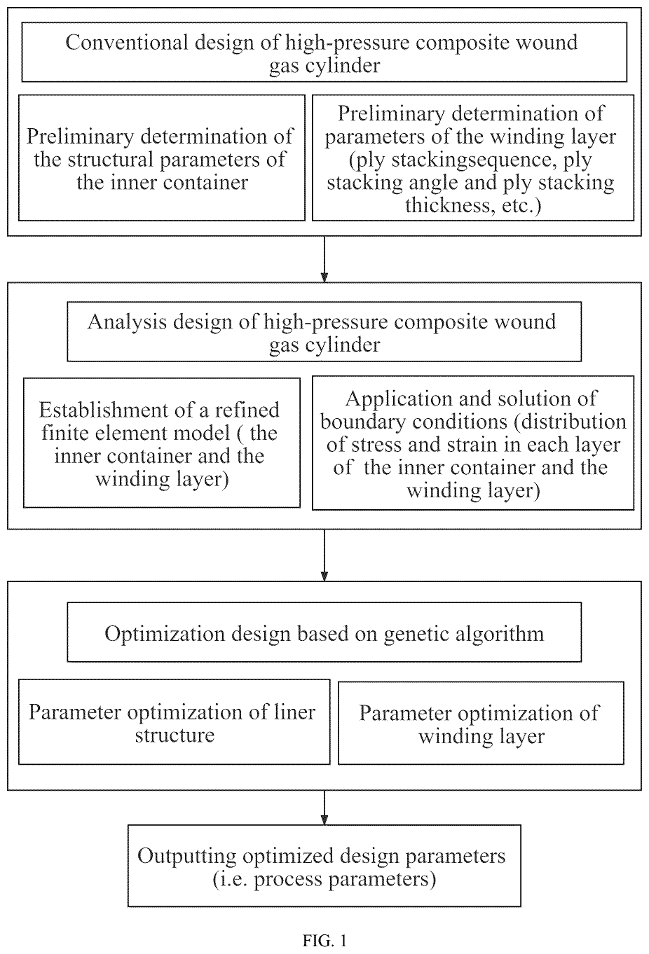

In this embodiment, as shown in FIG. 1, a method for optimizing a design of a high-pressure hydrogen storage composite wound gas cylinder includes:
S1, determining a preliminary design result according to a film theory and a grid theory, where the preliminary design result includes a thickness of an inner container of a high-pressure composite wound gas cylinder and a thickness of a composite reinforced layer;
in the S1, a process of determining the preliminary design result according to the thin film theory and the grid theory includes:
calculating the thickness of the inner container and the thickness of the reinforced layer of the high-pressure composite wound gas cylinder.

A method for calculating the thickness of the inner container of the high-pressure composite material wound gas cylinder includes following steps:
(1) a formula of the thickness of the inner container is as follows:

$${t}_{i} = \frac{{P}_{i} D}{2 {R}_{mi} + {P}_{i}}$$

where tᵢ represents the thickness of the inner container, Pᵢ represents a minimum design bursting pressure of the inner container, D represents an outer diameter of the inner container, and Rₘᵢ represents a minimum guaranteed value of a tensile strength of an inner container material after heat treatment;
a minimum thickness of a neck diameter of the inner container is calculated according to a following formula:

$${t}_{i 0 min} = \frac{{P}_{b} {d}_{i 0}}{2 {R}_{mi} + {P}_{b}}$$

where tᵢ₀ₘᵢₙ represents the minimum thickness of the neck diameter of the inner container, P_{b} represents an actual design bursting pressure of the gas cylinder, and dᵢ₀ represents an outer diameter of the inner container bottle mouth.
(2) a formula of a composite reinforced layer is as follows:

$${t}_{os} = \frac{{P}_{b} D - 4 {R}_{mi} {t}_{i}}{4 k {cos}^{2} α {R}_{mo}}$$

where tₒₛ represents a layer thickness of a spiral layer of the composite reinforced layer, Rₘₒ represents a minimum guaranteed value of a tensile strength of the composite, α represents a winding angle, k represents a balance coefficient, and the value range is 0.7-0.8 according to experience;

$${t}_{oh} = \frac{{P}_{b} D}{4 {R}_{mo}} ( 2 - \frac{1}{k} {tan}^{2} α ) - \frac{{R}_{mi} {t}_{i}}{{R}_{mo}}$$

where tₒₕ represents a thickness of a circumferential layer of the composite reinforced layer, and a circumferential reinforcement structure consists of two parts, one part is provided by the circumferential layer, and the other part is provided by the spiral layer.

A calculation formula of a minimum winding angle α₀ is as follows:

$${α}_{0} = {sin}^{- 1} \frac{{d}_{i 0}}{D}$$

When different winding angles are adopted to avoid pole hole accumulation and meet process requirements, a cosine or sine square ratio may be used for conversion.
a calculation formula of the thickness tₒ of the composite reinforced layer is as follows:

$${t}_{o} = {t}_{os} + {t}_{oh} .$$

Finally, through the calculation results and experience, as well as the thickness of single-layer composite, the ply stacking sequence, ply stacking angle and ply stacking thickness are preliminarily determined, and then the refined model is analyzed and designed according to a preliminary design result.

S2, establishing a three-dimensional solid refined model of the preliminary design result based on a finite element analysis method:

### (1) Establishing a Three-Dimensional Solid Refined Model

The refined model establishing is divided into two parts, one part is the establishment of an inner container model, and the other part is the establishment of a composite reinforced layer. The inner container is made of metal material or non-metal material, the metal inner container is a revolving body, and the non-metal inner container is a revolving assembly (the cylinder is non-metal, and the polar hole is metal); the establishment of the composite reinforced layer is complicated, and is divided into a circumferential layer modeling and a spiral layer modeling. The circumferential layer is performed with a ply stacking modeling by using 90° fibers, the spiral layer is performed with a ply stacking modeling according to a preliminarily designed ply angle, and the ply stacking modeling method with variable angle and thickness is used at the head. The modified cubic spline thickness formula is used for a data calculation and then the ply stacking modeling is carried out.

A process of establishing the three-dimensional solid refined model includes: the establishment of the inner container model, and the establishment of the composite reinforced layer.

A method for establishing the composite reinforced layer includes following steps:
the reinforced layer of composite material may be divided into a circumferential layer modeling and a spiral layer modeling. The circumferential layer is performed with a ply stacking modeling by using 90° fibers, the spiral layer is performed with a ply stacking modeling according to a preliminarily designed ply angle, and the ply stacking modeling method with variable angle and thickness is used at the head. The modified cubic spline thickness formula is used for a data calculation and then the ply stacking modeling is carried out.
a method for carrying out a ply stacking modeling after the data calculation by using the modified cubic spline thickness formula includes:
a modified cubic spline function for calculating a thickness of the head is as follows:

$$t ( {r}_{i} ) = {m}_{1} \times {r}_{i}^{0} + {m}_{2} \times {r}_{i}^{1} + {m}_{3} \times {r}_{i}^{2} + {m}_{4} \times {r}_{i}^{3}$$

where m₁, m₂, m₃, m₄ represent undetermined coefficients and rᵢ represents a distance from a central axis;

The modified cubic spline function uses the calculation formula of r_{2.2b} instead of the conventional calculation formula of fiber volume in two bandwidth ranges, the calculation formula of r_{2.2b} is more convenient for calculation and also avoids a peak of fiber accumulation within one-time bandwidth, a formula for determining m₁, m₂, m₃, m₄ is as follows:

$$[ \begin{matrix}{m}_{1} \\ {m}_{2} \\ {m}_{3} \\ {m}_{4}\end{matrix} ] = {[ \begin{matrix}1 & {r}_{0} & {r}_{0}^{2} & {r}_{0}^{3} \\ 1 & {r}_{2 b} & {r}_{2 b}^{2} & {r}_{2 b}^{3} \\ 0 & 1 & 2 {r}_{2 b} & 3 {r}_{2 b}^{2} \\ 1 & {r}_{2.2 b} & {r}_{2.2 b}^{2} & {r}_{2.2 b}^{3}\end{matrix} ]}^{- 1} \times [ \text{} \begin{matrix}{t}_{R} \cdot π R \cdot cos {α}_{0} / ( {m}_{0} \cdot b ) \\ \frac{{m}_{R} \cdot {n}_{R}}{π} \cdot [ arc cos ( \frac{{r}_{0}}{{r}_{2 b}} ) - arc cos ( \frac{{r}_{0} + b}{{r}_{2 b}} ) ] \cdot {t}_{p} \\ \frac{{m}_{R} \cdot {n}_{R}}{π} \cdot ( \frac{{r}_{0}}{{r}_{2 b} \times \sqrt{{r}_{2 b}^{2} - {r}_{0}^{2}}} - \frac{{r}_{b}}{{r}_{2 b} \times \sqrt{{r}_{2 b}^{2} - {r}_{0}^{2}}} ) \cdot {t}_{p} \\ \frac{{m}_{R} \cdot {n}_{R}}{π} \cdot [ arc cos ( \frac{{r}_{0}}{{r}_{2.2 b}} ) - arc cos ( \frac{{r}_{0} + b}{{r}_{2.2 b}} ) ] \cdot {t}_{p}\end{matrix} ]$$

where m_{R} represents a number of yarn bands in each single layer of a cylinder body, n_{R} represents a total number of single layers, tₚ represents a thickness of single layer yarn bands, m₀ represents a number of yarn pieces at a polar hole, m_{R}·n_{R} represents a total number of yarn bands, and m_{R}·n_{R}·tₚ represents a total thickness of yarn bands in the cylinder body.

Formulas for calculating a winding angle at the polar hole of the head are as follows:
a spherical head formula:

$$α = arc sin ( \frac{{r}_{0}}{R} ) \times \frac{180}{π}$$

an elliptical head formula:

$$α = arc sin ( \frac{{r}_{0}^{2}}{{r}_{0}^{2} + ( {R}^{2} - {r}_{0}^{2} ) \frac{{h}^{2}}{{R}^{2}}} ) \times \frac{180}{π}$$

where r₀ represents the polar hole radius, and R represents an outside radius of the cylinder body;
formulas for calculating a winding angle of the head are as follows:
a spherical head formula:

$$α = arc sin ( \frac{{r}_{0}}{{r}_{i}} ) \times \frac{180}{π}$$

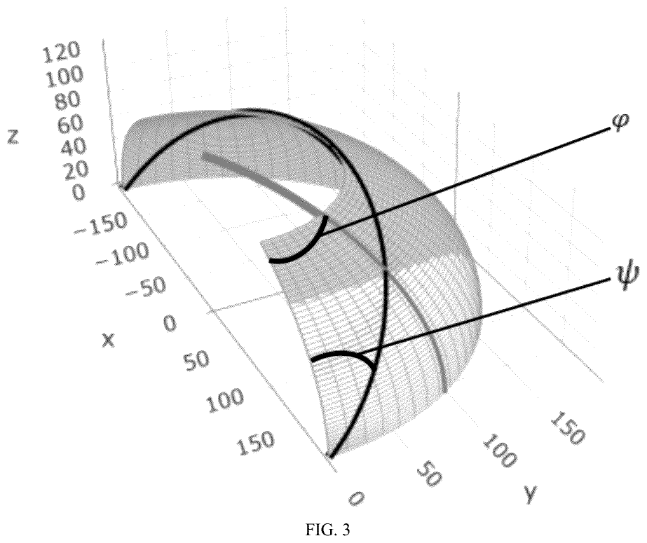

an elliptical head formula:

$$α = arc cos ( cos ψ \cdot cos φ \sqrt{\frac{{R}^{2} - ( {R}^{2} - {h}^{2} ) \cdot \frac{{sin}^{2} ψ}{{sin}^{2} ψ + {cos}^{2} ψ \cdot {sin}^{2} φ}}{{R}^{2} - ( {R}^{2} - {h}^{2} ) \cdot \frac{{cos}^{2} ψ \cdot {cos}^{2} φ \cdot {sin}^{2} ψ}{{sin}^{2} ψ + {cos}^{2} ψ \cdot {sin}^{2} φ}}} ) \times \frac{180}{π}$$

where rᵢ represents a radius from point i at the head to a rotating shaft, ψ represents an included angle between a plane where a geodesic line is located and an XZ plane, and φ represents an included angle between a plane of meridian and the XZ plane, as shown in FIG. 3, a method for calculating ψ and φ is as follows:

$${sin}^{2} ψ = \frac{{r}_{0}^{2}}{{R}^{2}}$$

$${sin}^{2} φ = \frac{{R}^{2} - {r}^{2}}{{r}^{2}} \cdot \frac{{r}_{0}^{2}}{{R}^{2} - {r}_{0}^{2}} .$$

### (2) Material Attribute Setting

Failure criteria need to be added to the material property setting, such as three-dimensional Hashin and LaRC04 failure criteria, or progressive failure model to improve the calculation accuracy, but the calculation time becomes longer.

### (3) Application and Solution of Boundary Conditions

One end of the gas cylinder is fixed or other fixed constraints are selected; the load is pressurized on an inner surface of the inner container, where a self-tightening pressure of a metal inner container needs to be calculated, and a CAE analysis and calculation are carried out after loading. The pressure loading process is as follows:
process 1: the internal pressure of the gas cylinder rises from a zero pressure to the self-tightening pressure;
process 2: the internal pressure of the gas cylinder declines from the self-tightening pressure to the zero pressure;
process 3: the internal pressure of the gas cylinder rises from the zero pressure to a nominal working pressure;
process 4: the internal pressure of the gas cylinder rises from the nominal working pressure to a hydraulic fatigue test pressure (1.3 times the working pressure);
process 5: the internal pressure of the gas cylinder rises from the hydraulic fatigue test pressure to a hydraulic test pressure of the gas cylinder (1.5 times the working pressure); and
process 6: the internal pressure of the gas cylinder rises from the hydraulic test pressure of the gas cylinder to a hydraulic bursting pressure of the gas cylinder (2.35 times the working pressure);
where the self-tightening pressure is estimated by several groups of data for trial calculation, and then the self-tightening pressure is determined according to following restrictions:
a, under the working pressure, the fiber stress of the winding layer cannot exceed 30% of a strength limit;
b, under the working pressure, the stress of the metal inner container cannot exceed 60% of a yield limit;
c, under the zero pressure, a compressive stress of the metal inner container cannot exceed 95% of the yield limit, but is above 60% of the yield limit; and
d, the maximum stress at the head of the winding layer of the gas cylinder is always less than the maximum stress at the cylinder body.

In the process of CAE solution, nonlinear and large deformation options need to be turned on to obtain more accurate results.

### (4) Post-Processing of Results

The overall stress evaluation of gas cylinder inner container may be based on Von Mises stress less than tensile strength, and the local stress may be evaluated according to the stress analysis method provided by analysis and design standards, that is, the primary bending stress is less than 1.5 times the yield strength, the local film stress is less than 1.5 times the yield strength, and the primary stress plus the secondary stress is less than 3 times the yield strength.

The stress evaluation of gas cylinder winding layer is evaluated according to LaRC04 criterion, which may be used to judge whether the gas cylinder winding layer is invalid under the blasting pressure, and this method may also be used to calculate the actual blasting pressure.

S3, carrying out a multi-objective optimization design of the high-pressure composite wound gas cylinder by applying a response surface or a genetic algorithm based on the three-dimensional solid refined model.

Based on the response surface or the genetic algorithm, the multi-objective optimization design of high-pressure composite wound gas cylinder is carried out. The multi-objective optimization design of high-pressure composite wound gas cylinder takes ply stacking angle, ply stacking sequence and ply stacking number as design variables, takes weight of gas cylinder winding layer, fiber direction stress and fiber tangential stress as objective functions and takes the blasting pressure as a constraint condition.

Optionally, in S3, a process of applying the response surface or the genetic algorithm to carry out the optimization design includes:
carrying out a simulation analysis according to the built refined simulation model; and
applying the response surface or the genetic algorithm to carry out the optimization design.

A mathematical model is built as follows:

$$min F ( x ) = ( {f}_{1} ( x ) , {f}_{2} ( x ) , {f}_{3} ( x ) )$$

where F(x) represents the objective function, ƒ₁(x) represents the mass of winding layer; ƒ₂(x) represents the fiber direction stress, ƒ₃(x) represents the fiber tangential stress, and P(x)≤P_{b} represents the constraint condition.

The mathematical model is an optimized design objective function model.

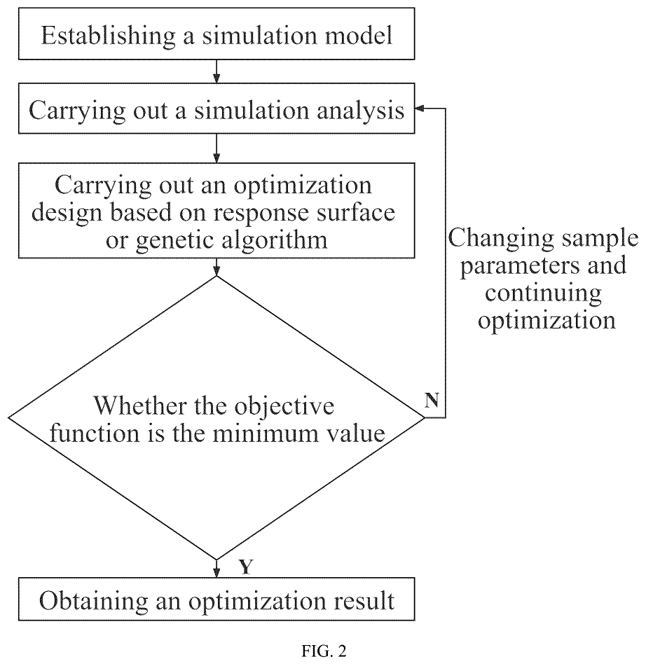

As shown in FIG. 2, firstly, the simulation model is established, and then the refined model is used for simulation analysis. Finally, the response surface or the genetic algorithm is used for optimization design. According to the computer capacity, the optimization method, the sample number and the iteration times are selected. Generally, the number of candidate points is three, and the minimum value of the objective function meeting the constraint condition is the optimization result. Otherwise, the parameters are modified and the optimization program is continued.

### Embodiment 2

The disclosure relates to a system for optimizing a design of a high-pressure hydrogen storage composite wound gas cylinder, the system includes a preliminary design result acquisition module, a model establishment module and a multi-objective optimization design module;
the preliminary design result acquisition module is used for determining a preliminary design result according to a film theory and a grid theory, and the preliminary design result includes a thickness of an inner container of a high-pressure composite wound gas cylinder and a thickness of a composite reinforced layer;
the model establishment module is used for establishing a three-dimensional solid refined model of the preliminary design result based on a finite element analysis method; and
the multi-objective optimization design module is used for carrying out a multi-objective optimization design of the high-pressure composite wound gas cylinder by applying a response surface or a genetic algorithm based on the three-dimensional solid refined model.

The above-mentioned embodiments are only a description of the preferred mode of this disclosure, not a limitation on the scope of this disclosure. Without departing from the design spirit of this disclosure, various modifications and improvements made by ordinary technicians in this field to the technical scheme of this disclosure shall fall within the protection scope determined by the claims of the disclosure.

What is claimed is:

1. A method for optimizing a design of a high-pressure hydrogen storage composite wound gas cylinder, comprising following steps:
S1, determining a preliminary design result according to a film theory and a grid theory, wherein the preliminary design result comprises a thickness of an inner container of a high-pressure composite wound gas cylinder and a thickness of a composite reinforced layer;
S2, establishing a three-dimensional solid refined model of the preliminary design result based on a finite element analysis method; and
S3, carrying out a multi-objective optimization design of the high-pressure composite wound gas cylinder by applying a response surface or a genetic algorithm based on the three-dimensional solid refined model.

2. The method for optimizing the design of the high-pressure hydrogen storage composite wound gas cylinder according to claim 1, wherein a method for calculating the thickness of the inner container of the high-pressure composite material wound gas cylinder comprises following steps:
$${t}_{i} = \frac{{P}_{i} D}{2 {R}_{mi} + {P}_{i}}$$
wherein tᵢ represents the thickness of the inner container, Pᵢ represents a minimum design bursting pressure of the inner container, D represents an outer diameter of the inner container, and Rₘᵢ represents a minimum guaranteed value of a tensile strength of an inner container material after heat treatment;
a minimum thickness of a neck diameter of the inner container is calculated according to a following formula:
$${t}_{i 0 min} = \frac{{P}_{b} {d}_{i 0}}{2 {R}_{mi} + {P}_{b}}$$
wherein tᵢ₀ₘᵢₙ represents the minimum thickness of the neck diameter of the inner container, P_{b} represents an actual design bursting pressure of the gas cylinder, and dᵢ₀ represents an outer diameter of the inner container bottle mouth.

3. The method for optimizing the design of the high-pressure hydrogen storage composite wound gas cylinder according to claim 2, wherein a method for calculating the thickness of the composite reinforced layer comprises:
$${t}_{os} = \frac{{P}_{b} D - 4 {R}_{mi} {t}_{i}}{4 k {cos}^{2} α {R}_{mo}}$$
wherein tₒₛ represents a layer thickness of a spiral layer of the composite reinforced layer, Rₘₒ represents a minimum guaranteed value of a tensile strength of the composite, α represents a winding angle and k represents a balance coefficient;
$${t}_{oh} = \frac{{P}_{b} D}{4 {R}_{mo}} ( 2 - \frac{1}{k} {tan}^{2} α ) - \frac{{R}_{mi} {t}_{i}}{{R}_{mo}}$$
wherein tₒₕ represents a thickness of a circumferential layer of the composite reinforced layer, and a circumferential reinforcement structure consists of two parts, one part is provided by the circumferential layer, and an other part is provided by the spiral layer; and
a calculation formula of the thickness tₒ of the composite reinforced layer is:
$${t}_{o} = {t}_{os} + {t}_{oh} .$$

4. The method for optimizing the design of the high-pressure hydrogen storage composite wound gas cylinder according to claim 1, wherein in the S2, a process of establishing the three-dimensional solid refined model comprises an establishment of the inner container model and an establishment of the composite reinforced layer.

5. The method for optimizing the design of the high-pressure hydrogen storage composite wound gas cylinder according to claim 4, wherein a method for establishing the composite reinforced layer comprises following steps:
the reinforced layer of composite material may be divided into a circumferential layer modeling and a spiral layer modeling; the circumferential layer is performed with a ply stacking modeling by using 90° fibers, the spiral layer is performed with a ply stacking modeling according to a preliminarily designed ply angle, and the ply stacking modeling method with variable angle and thickness is used at a head; the modified cubic spline thickness formula is used for a data calculation and then the ply stacking modeling is carried out.

6. The method for optimizing the design of the high-pressure hydrogen storage composite wound gas cylinder according to claim 4, wherein a method for carrying out a ply stacking modeling after the data calculation by using the modified cubic spline thickness formula comprises:
a modified cubic spline function for calculating a thickness of the head is as follows:
$$t ( {r}_{i} ) = {m}_{1} \times {r}_{i}^{0} + {m}_{2} \times {r}_{i}^{1} + {m}_{3} \times {r}_{i}^{2} + {m}_{4} \times {r}_{i}^{3}$$
wherein m₁, m₂, m₃, m₄ represent undetermined coefficients and rᵢ represents a distance from a central axis;
a formula for determining m₁, m₂, m₃, m₄ is as follows:
$$[ \begin{matrix}{m}_{1} \\ {m}_{2} \\ {m}_{3} \\ {m}_{4}\end{matrix} ] = {[ \begin{matrix}1 & {r}_{0} & {r}_{0}^{2} & {r}_{0}^{3} \\ 1 & {r}_{2 b} & {r}_{2 b}^{2} & {r}_{2 b}^{3} \\ 0 & 1 & 2 {r}_{2 b} & 3 {r}_{2 b}^{2} \\ 1 & {r}_{2 \text{.2} b} & {r}_{2.2 b}^{2} & {r}_{2.2 b}^{3}\end{matrix} ]}^{- 1} \times [ \text{} \begin{matrix}{t}_{R} \cdot π R \cdot cos {α}_{0} / ( {m}_{0} \cdot b ) \\ \frac{{m}_{R} \cdot {n}_{R}}{π} \cdot [ arc cos ( \frac{{r}_{0}}{{r}_{2 b}} ) - arc cos ( \frac{{r}_{0} + b}{{r}_{2 b}} ) ] \cdot {t}_{p} \\ \frac{{m}_{R} \cdot {n}_{R}}{π} \cdot ( \frac{{r}_{0}}{{r}_{2 b} \times \sqrt{{r}_{2 b}^{2} - {r}_{0}^{2}}} - \frac{{r}_{b}}{{r}_{2 b} \times \sqrt{{r}_{2 b}^{2} - {r}_{b}^{2}}} ) \cdot {t}_{p} \\ \frac{{m}_{R} \cdot {n}_{R}}{π} \cdot [ arc cos ( \frac{{r}_{0}}{{r}_{2.2 b}} ) - arc cos ( \frac{{r}_{0} + b}{{r}_{2.2 b}} ) ] \cdot {t}_{p}\end{matrix} ]$$
wherein m_{R} represents a number of yarn bands in each single layer of a cylinder body, n_{R} represents a total number of single layers, tₚ represents a thickness of single layer yarn bands, m₀ represents a number of yarn pieces at a polar hole, m_{R}·n_{R} represents a total number of yarn bands, and m_{R}·n_{R}·tₚ represents a total thickness of yarn bands in the cylinder body;
formulas for calculating a winding angle at the polar hole of the head are as follows:
a spherical head formula:
$$α = arc sin ( \frac{{r}_{0}}{R} ) \times \frac{180}{π}$$
an elliptical head formula:
$$α = arc sin ( \frac{{r}_{0}^{2}}{{r}_{0}^{2} + ( {R}^{2} - {r}_{0}^{2} ) \frac{{h}^{2}}{{R}^{2}}} ) \times \frac{180}{π}$$
wherein r₀ represents the polar hole radius, and R represents an outside radius of the cylinder body;
formulas for calculating a winding angle of the head are as follows:
a spherical head formula:
$$α = arc sin ( \frac{{r}_{0}}{{r}_{i}} ) \times \frac{180}{π}$$
an elliptical head formula:
$$α = arc cos ( cos ψ \cdot cos φ \sqrt{\frac{{R}^{2} - ( {R}^{2} - {h}^{2} ) \cdot \frac{{sin}^{2} ψ}{{sin}^{2} ψ + {cos}^{2} ψ \cdot {sin}^{2} φ}}{{R}^{2} - ( {R}^{2} - {h}^{2} ) \cdot \frac{{cos}^{2} ψ \cdot {cos}^{2} φ \cdot {sin}^{2} ψ}{{sin}^{2} ψ + {cos}^{2} ψ \cdot {sin}^{2} φ}}} ) \times \frac{180}{π}$$
wherein rᵢ represents a radius from point i at the head to a rotating shaft, ψ represents an included angle between a plane where a geodesic line is located and an XZ plane, and φ represents an included angle between a plane of meridian and the XZ plane, and a method for calculating ψ and φ is as follows:
$${sin}^{2} ψ = \frac{{r}_{0}^{2}}{{R}^{2}}$$
$${sin}^{2} φ = \frac{{R}^{2} - {r}^{2}}{{r}^{2}} \cdot \frac{{r}_{0}^{2}}{{R}^{2} - {r}_{0}^{2}} .$$

7. The method for optimizing the design of the high-pressure hydrogen storage composite wound gas cylinder according to claim 1, wherein an application and a solution of boundary conditions are further comprised in the S2:
one end of the gas cylinder is fixed or other fixed constraints are selected; a load is pressurized on an inner surface of the inner container, wherein a self-tightening pressure of a metal inner container needs to be calculated, and CAE analysis and calculation are carried out after loading; a pressure loading process is as follows:
process 1: an internal pressure of the gas cylinder rises from a zero pressure to the self-tightening pressure;
process 2: the internal pressure of the gas cylinder declines from the self-tightening pressure to the zero pressure;
process 3: the internal pressure of the gas cylinder rises from the zero pressure to a nominal working pressure;
process 4: the internal pressure of the gas cylinder rises from the nominal working pressure to a hydraulic fatigue test pressure;
process 5: the internal pressure of the gas cylinder rises from the hydraulic fatigue test pressure to a hydraulic test pressure of the gas cylinder; and
process 6: the internal pressure of the gas cylinder rises from the hydraulic test pressure of the gas cylinder to a hydraulic bursting pressure of the gas cylinder;
wherein the self-tightening pressure is estimated by several groups of data for trial calculation, and then the self-tightening pressure is determined according to following restrictions:
a, under a working pressure, a fiber stress of the winding layer cannot exceed 30% of a strength limit;
b, under the working pressure, a stress of the metal inner container cannot exceed 60% of a yield limit;
c, under the zero pressure, a compressive stress of the metal inner container cannot exceed 95% of the yield limit, but is above 60% of the yield limit; and
d, the maximum stress at the head of the winding layer of the gas cylinder is always less than the maximum stress at the cylinder body.

8. A system for optimizing a design of a high-pressure hydrogen storage composite wound gas cylinder, comprising a preliminary design result acquisition module, a model establishment module and a multi-objective optimization design module;
the preliminary design result acquisition module is used for determining a preliminary design result according to a film theory and a grid theory, and the preliminary design result comprises a thickness of an inner container of a high-pressure composite wound gas cylinder and a thickness of a composite reinforced layer;
the model establishment module is used for establishing a three-dimensional solid refined model of the preliminary design result based on a finite element analysis method; and
the multi-objective optimization design module is used for carrying out a multi-objective optimization design of the high-pressure composite wound gas cylinder by applying a response surface or a genetic algorithm based on the three-dimensional solid refined model.
